(19) United States
(12) Patent Application Publication
(10) Pub. No.: US 2026/0362198 A1
(43) Pub. Date: Nov. 12, 2026

(54) METHODS AND APPARATUSES FOR CONFIGURATION OF ENHANCED DELAY STATUS REPORTING IN MOBILE COMMUNICATIONS

(71) Applicant: HTC Corporation, Taoyuan City (TW)

(72) Inventor: Yen-Yi Lee, Taoyuan City (TW)

(21) Appl. No.: 19/452,656

(22) Filed: Jan. 19, 2026

Related U.S. Application Data
(60) Provisional application No. 63/804,619, filed on May 12, 2025.
(60) Provisional application No. 63/804,661, filed on May 13, 2025.

(51) Int. Cl. H04W 24/10; H04L 43/0852

(52) U.S. Cl. CPC H04W 24/10; H04L 43/0852

(57) ABSTRACT

Various solutions for configuration of enhanced delay status reporting (DSR) in mobile communications are described. An apparatus may receive a radio resource control (RRC) signaling including a MAC-CellGroupConfig information element (IE) from a network node. The MAC-CellGroupConfig IE includes a remaining time threshold for triggering a DSR procedure for logical channel(s) within a logical channel group (LCG), and further includes a plurality of reporting thresholds on remaining time for reporting delay status information of the LCG, such that any LCG configured with the remaining time threshold is also configured with the plurality of reporting thresholds. Then, the apparatus may trigger the DSR procedure for the logical channel(s) based on the remaining time threshold, and transmit a DSR medium access control (MAC) control element (CE) to the network node, which includes a plurality of entries of delay status information of the LCG, each entry being associated with one reporting threshold.

### CROSS REFERENCE TO RELATED PATENT APPLICATION(S)

The present disclosure claims the priority benefit of U.S. Patent Application No. 63/804,619, filed on 12 May 2025, and U.S. Patent Application No. 63/804,661, filed 13 May 2025. The contents of U.S. Patent Application No. 63/804,619 and U.S. Patent Application No. 63/804,661 are herein incorporated by reference in their entireties.

### TECHNICAL FIELD

The present disclosure is generally related to mobile communications and, more particularly, to configuration of enhanced delay status reporting (DSR) in mobile communications.

### BACKGROUND

Unless otherwise indicated herein, approaches described in this section are not prior art to the claims listed below and are not admitted as prior art by inclusion in this section.

The wireless communications network has grown exponentially over the years. A long-term evolution (LTE) system offers high peak data rates, low latency, improved system capacity, and low operating cost resulting from simplified network architecture. LTE systems, also known as the 4^{th} generation (4G) system, also provide seamless integration to older wireless network, such as GSM, CDMA and universal mobile telecommunication system (UMTS). In LTE systems, an evolved universal terrestrial radio access network (E-UTRAN) includes a plurality of evolved Node-Bs (eNodeBs or eNBs) communicating with a plurality of mobile stations, referred to as user equipment (UE). Alternatively, a wireless network may include a hybrid of 2G/3G/4G systems. In 3^{rd} generation partner project (3GPP), the next generation mobile network (NGMN) board has decided to focus the future NGMN activities on defining the end-to-end requirements for 5^{th} generation (5G) new radio (NR) systems, 5G-advanced systems, and 6^{th} Generation (6G) systems.

In 3GPP Release 18 for 5G NR, the DSR procedure is introduced to provide the serving next generation Node-B (gNB) with delay status information of logical channel groups (LCGs) via a DSR medium access control (MAC) control element (CE). This reporting allows the delivery of delay-critical packet data convergence protocol (PDCP) service data units (SDUs) to be handled promptly as required by certain delay-sensitive services, such as extended reality (XR), remote control and teleoperation/telesurgery, industrial automation, and vehicle-to-everything (V2X) services. Based on the reported delay status information, the serving gNB may perform scheduling more efficiently and effectively to improve system capacity, e.g., by relaxing time constraints for resource allocation, while still meeting delay requirements (i.e., avoiding excessively late protocol data units (PDUs)). However, the current design of the DSR procedure may nevertheless exhibit inefficiencies with respect to uplink (UL) data and resource scheduling. For example, the DSR procedure is restricted to reporting only one pair of the remaining time (i.e., the shortest remaining value of all running PDCP discardTimers) and the buffer size (i.e., the total amount of delay-critical UL data) per LCG. As a result, the gNB is unaware of the remaining times of other PDCP SDUs associated with running PDCP discardTimers having longer remaining times. In other words, the gNB is unable to obtain the delay status information with more details or with finer granularity regarding the delay-critical data buffered in the LCG, and this inevitably reduces the flexibility of UL data and resource scheduling.

Therefore, there is a need to provide proper schemes to address this issue.

### SUMMARY

The following summary is illustrative only and is not intended to be limiting in any way. That is, the following summary is provided to introduce concepts, highlights, benefits, and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

One objective of the present disclosure is proposing schemes, concepts, designs, systems, methods, and/or apparatus pertaining to configuration of enhanced DSR in mobile communications. It is believed that the above-described issue would be avoided or otherwise alleviated by implementing one or more of the proposed schemes described herein.

In one aspect, an apparatus may comprise a transceiver that, during operation, wirelessly communicates with a network node. The apparatus may also comprise a processor communicatively coupled to the transceiver. The processor, during operation, may perform operations comprising receiving, via the transceiver, a radio resource control (RRC) signaling comprising a MAC-CellGroupConfig information element (IE) from the network node, wherein the MAC-CellGroupConfig IE comprises a remaining time threshold for triggering a DSR procedure for one or more logical channels within an LCG, and further comprises a plurality of reporting thresholds on remaining time for reporting delay status information of the LCG, such that any LCG configured with the remaining time threshold is also configured with the plurality of reporting thresholds. The processor may also perform operations comprising triggering the DSR procedure for the one or more logical channels based on the remaining time threshold. The processor may further perform operations comprising transmitting, via the transceiver, a DSR MAC CE to the network node responsive to triggering the DSR procedure, wherein the DSR MAC CE comprises a plurality of entries of the delay status information of the LCG, each of the plurality of entries being associated with one of the plurality of reporting thresholds.

In one aspect, a network node may comprise a transceiver which, during operation, wirelessly communicates with an apparatus. The network node may also comprise a processor communicatively coupled to the transceiver. The processor, during operation, may perform operations comprising transmitting, via the transceiver, an RRC signaling comprising a MAC-CellGroupConfig IE to the apparatus, wherein the MAC-CellGroupConfig IE comprises a remaining time threshold for triggering a DSR procedure for one or more logical channels within an LCG, and further comprises a plurality of reporting thresholds on remaining time for reporting delay status information of the LCG, such that any LCG configured with the remaining time threshold is also configured with the plurality of reporting thresholds. The processor may further perform operations comprising receiving, via the transceiver, a DSR MAC CE from the apparatus in the DSR procedure, wherein the DSR MAC CE comprises a plurality of entries of the delay status information of the LCG, each of the plurality of entries being associated with one of the plurality of reporting thresholds.

It is noteworthy that, although description provided herein may be in the context of certain radio access technologies, networks and network topologies such as LTE, LTE-Advanced, LTE-Advanced Pro, 5G, NR, Internet-of-Things (IoT) and Narrow Band Internet of Things (NB-IoT), Industrial Internet of Things (IIoT), beyond 5G (B5G), and 6G, the proposed concepts, schemes and any variation(s)/derivative(s) thereof may be implemented in, for and by other types of radio access technologies, networks and network topologies. Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale, as some components may be shown to be out of proportion than the size in actual implementation in order to clearly illustrate the concept of the present disclosure.

FIG. 1 is a diagram depicting an example scenario of the format of a DSR MAC CE under current 5G NR framework.

FIG. 2 is a diagram depicting an example scenario of a communication environment in which various solutions and schemes in accordance with the present disclosure may be implemented.

FIG. 3 is a diagram depicting an example scenario of the enhanced DSR procedure in accordance with an implementation of the present disclosure.

FIG. 4 is a diagram depicting an example scenario of enhanced delay status reporting via a DSR MAC CE in accordance with an implementation of the present disclosure.

FIG. 5 is a block diagram of an example communication system in accordance with an implementation of the present disclosure.

FIG. 6 is a flowchart of an example process in accordance with an implementation of the present disclosure.

FIG. 7 is a flowchart of another example process in accordance with an implementation of the present disclosure.

### DETAILED DESCRIPTION OF PREFERRED IMPLEMENTATIONS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Implementations in accordance with the present disclosure relate to various techniques, methods, schemes, and/or solutions pertaining to configuration of enhanced DSR in mobile communications. According to the present disclosure, a number of possible solutions may be implemented separately or jointly. That is, although these possible solutions may be described below separately, two or more of these possible solutions may be implemented in one combination or another.

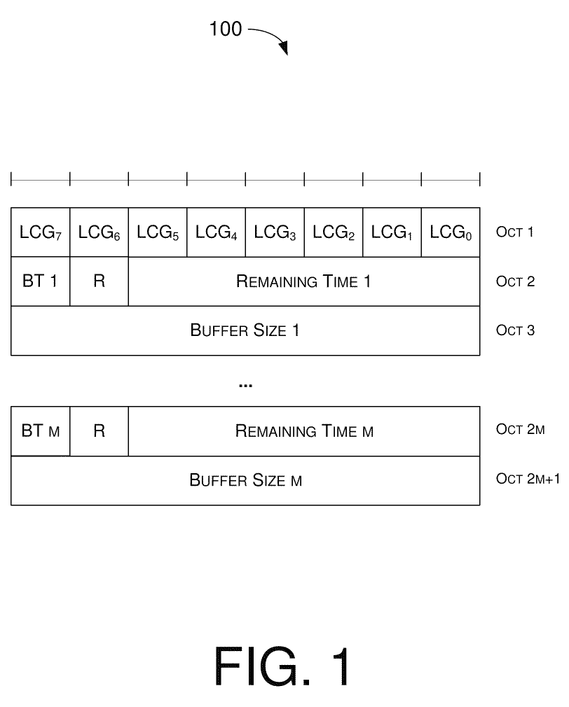

FIG. 1 illustrates an example scenario 100 of the format of a DSR MAC CE under current 5G NR framework. As shown in FIG. 1, a DSR MAC CE may carry delay status information for multiple LCGs (denoted as LCGᵢ, where i=0~7), but the delay status information for an LCH includes only a single pair of a remaining time field and a buffer size field. Such a DSR MAC CE is also called a Single Entry DSR MAC CE The remaining time field indicates the shortest remaining time of the running PDCP discardTimers among all PDCP SDUs that are buffered for the LCG but have not been transmitted in any MAC PDU. The buffer size field indicates the total amount of delay-critical UL data for the LCG. Due to the restriction that only a single pair of the remaining time field and the buffer size field can be reported for each LCG (i.e., only one entry of delay status information is reported per LCG), the scheduling of UL data and resources may become inefficient and ineffective.

In view of the above, the present disclosure proposes a number of schemes pertaining to configuration of enhanced DSR in mobile communications. According to the schemes of the present disclosure, the DSR procedure is enhanced by configuring both: (i) a remaining time threshold for triggering a DSR procedure for the logical channel(s) within an LCG, and (ii) multiple reporting thresholds (e.g., configured in a DSR reporting threshold list) for the LCG. As such, this configuration ensures that if at least one LCG is configured with a DSR reporting threshold list, any LCG configured with a remaining time threshold is also configured with a DSR reporting threshold list. Therefore, the undesirable situation in which the UE is configured to apply the enhanced DSR procedure for an LCG while no reporting threshold is configured for that LCG may be avoided. Furthermore, the enhanced DSR procedure allows a DSR MAC CE to contain multiple entries of delay status information of the LCG, where each entry is associated with one of the reporting thresholds. Specifically, each entry may include a pair of the remaining time field and the buffer size field associated with one of the configured reporting thresholds. Accordingly, by applying the schemes of the present disclosure, normal operation of the enhanced DSR procedure may be ensured, such that the reported delay status information includes more detailed information (e.g., the distribution of the remaining times) of the delay-critical data, thereby improving the efficiency and effectiveness of UL data and resource scheduling.

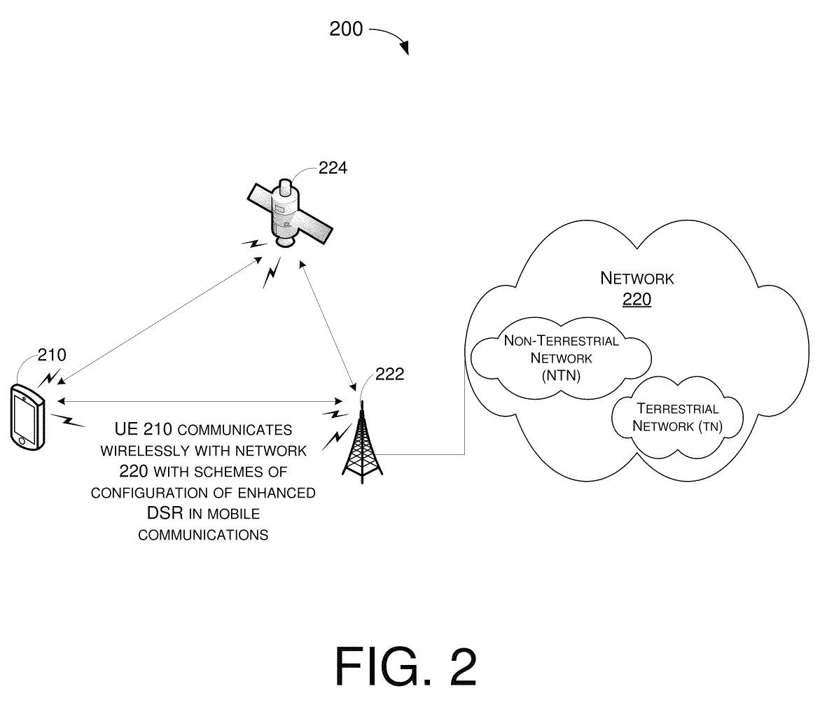

FIG. 2 illustrates an example scenario 200 of a communication environment in which various solutions and schemes in accordance with the present disclosure may be implemented. Scenario 200 involves a UE 210 in wireless communication with a network 220 (e.g., a wireless network including a non-terrestrial network (NTN) and a TN) via at least a terrestrial network node 222 (e.g., a base station (BS) such as an eNB, a gNB, or a transmission/reception point (TRP)) and/or at least a non-terrestrial network node 224 (e.g., a satellite). For example, the terrestrial network node 222 may form a TN serving cell for wireless communication with the UE 210, or the terrestrial network node 222 and the non-terrestrial network node 224 may form an NTN serving cell for wireless communication with the UE 210. In some implementations, the network 220 may be a 4G/5G/B5G/6G network, and the UE 210 may be a smartphone, a tablet computer, a laptop computer, or a notebook computer. Alternatively, the network 220 may be an IoT/ NB-IoT/IIoT network, and the UE 210 may be an IoT device such as an NB-IoT UE or an enhanced machine-type communication (eMTC) UE (e.g., a bandwidth reduced low complexity (BL) UE or a coverage enhancement (CE) UE). In such communication environment, the UE 210, the network 220, the terrestrial network node 222, and/or the non-terrestrial network node 224 may implement various schemes pertaining to configuration of enhanced DSR in mobile communications in accordance with the present disclosure, as described below. It is noteworthy that, while the various proposed schemes may be individually or separately described below, in actual implementations, some or all of the proposed schemes may be utilized or otherwise implemented jointly. Of course, each of the proposed schemes may be utilized or otherwise implemented individually or separately.

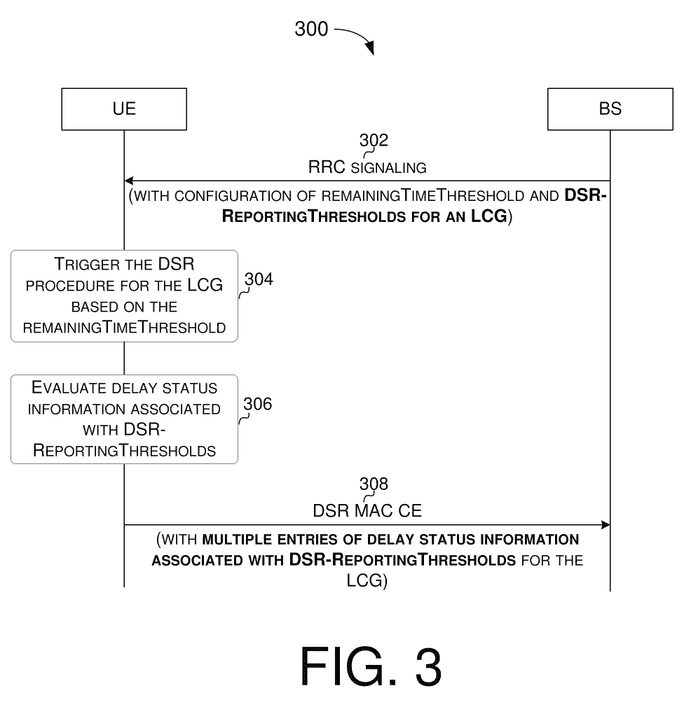

FIG. 3 illustrates an example scenario 300 of the enhanced DSR procedure in accordance with an implementation of the present disclosure. In step 302, the UE receives an RRC signaling from the BS. Specifically, the RRC signaling includes the configuration of a remaining time threshold (denoted as remainingTimeThreshold in FIG. 3) for triggering the DSR procedure for the logical channel(s) within an LCG, and multiple reporting thresholds (denoted as DSR-ReportingThresholds in FIG. 3) on remaining time for reporting delay status information of the LCG. The data (e.g., each PDCP SDU) of a logical channel is associated with a discard timer (e.g., PDCP discardTimer), and if the remaining time of the discard timer is less than the remaining time threshold, the data is considered as delay-critical data. If the data does not get transmitted before the discard timer expires, then the data is discarded. The reporting thresholds may be provided as a list of thresholds (e.g., called DSR-reportingThresList) on remaining time for reporting the amount of UL data buffered in an LCG. In one example, the reporting thresholds may be configured in ascending order (e.g., DSR-ReportingThreshold#1=3 milliseconds (ms), DSR-ReportingThreshold#2=5 ms, and DSR-ReportingThreshold#3=12 ms, etc.). The configuration may be contained in a MAC-CellGroupConfig IE of the RRC signaling.

Next, in step 304, the UE triggers the DSR procedure for the logical channel(s) belonging to the LCG (i.e., the DSR procedure is triggered for the LCG) based on the remaining time threshold. Specifically, the DSR procedure is triggered when at least one logical channel within the LCG carries data with a remaining time of an associated PDCP discard timer less than the remaining time threshold. In step 306, the UE evaluates the delay status information associated with the reporting thresholds. Specifically, for each logical channel of the LCG, the UE may check if the shortest remaining time of the running PDCP discardTimers among all the PDCP SDUs buffered for the logical channel becomes below any of the reporting thresholds, and if so, calculates the total amount of delay-critical data associated with the corresponding reporting threshold. In step 308, the UE transmits a DSR MAC CE including multiple entries of delay status information associated with the reporting thresholds for the LCG to the BS. Such a DSR MAC CE is also called a Multiple Entry DSR MAC CE, and this enhanced DSR is also called a Multiple Entry DSR.

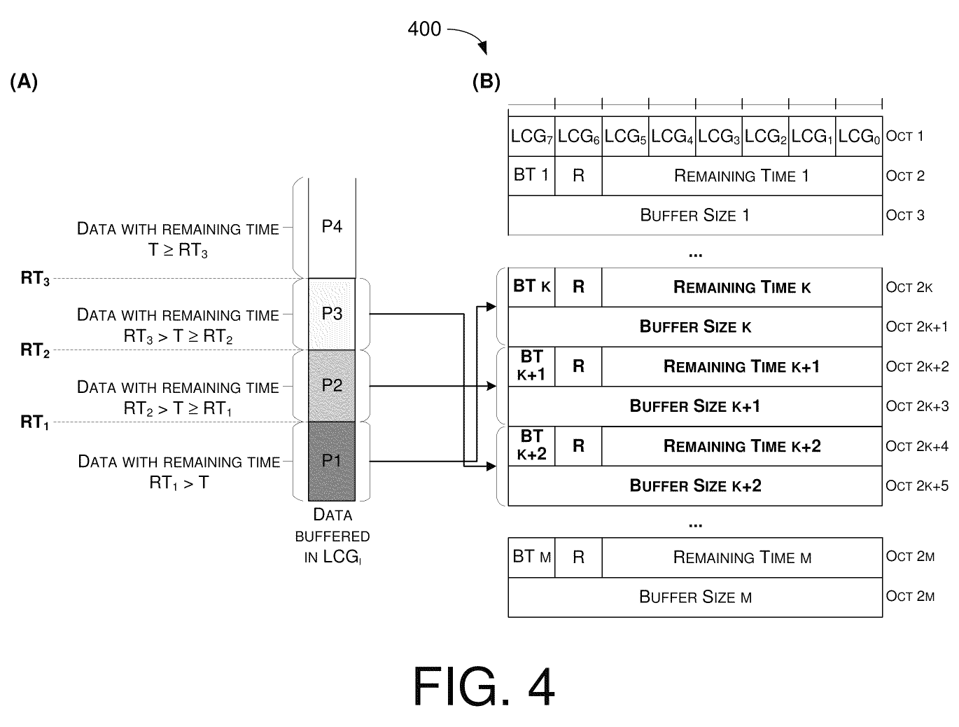

FIG. 4 illustrates an example scenario 400 of enhanced delay status reporting via a DSR MAC CE in accordance with an implementation of the present disclosure. Part (A) of FIG. 4 shows the buffer status for LCGᵢ, wherein the buffered PDCP SDUs that have not been transmitted in any MAC PDU are divided into multiple groups (e.g., 3 groups) based on the reporting thresholds (denoted as RT₁ to RT₃, where RT₁ < RT₂ < RT₃) configured for the LCGᵢ. For example, group P1 contains the PDCP SDUs with remaining time T smaller than the first reporting threshold (i.e., RT₁), group P2 contains the PDCP SDUs with remaining time T greater than or equal to the first reporting threshold (i.e., RT₁) and smaller than the second reporting threshold (i.e., RT₂), group P3 contains the PDCP SDUs with remaining time T greater than or equal to the second reporting threshold (i.e., RT₂) and smaller than the third reporting threshold (i.e., RT₃), and group P4 contains the PDCP SDUs with remaining time T greater than or equal to the third reporting threshold (i.e., RT₃). Part (B) of FIG. 4 shows a Multiple Entry DSR MAC CE containing multiple entries of delay status information of the LCGᵢ, and each entry is associated with one of the reporting thresholds configured for the LCG. Specifically, for group P1, there may be a corresponding entry of delay status information to be reported in the Multiple Entry DSR MAC CE, and the corresponding entry may include a pair of a buffer size field and a remaining time field, where the buffer size field indicates the total amount of delay-reporting data (e.g., delay-reporting PDCP SDUs) in all DSR-triggered logical channels with remaining time smaller than RT₁, and the remaining time field indicates the shortest remaining value of running PDCP discardTimers among all PDCP SDUs in all DSR-triggered logical channels with remaining time smaller than RT₁. For group P2, there may be a corresponding entry of delay status information to be reported in the Multiple Entry DSR MAC CE, and the corresponding entry may include a pair of a buffer size field and a remaining time field, where the buffer size field indicates the total amount of delay-reporting data in all DSR-triggered logical channels with remaining time greater than or equal to RT₁and smaller than RT₂, and the remaining time field indicates the shortest remaining value of running PDCP discardTimers among all PDCP SDUs in all DSR-triggered logical channels with remaining time greater than or equal to RT₁ and smaller than RT₂. For group P3, there may be a corresponding entry of delay status information to be reported in the Multiple Entry DSR MAC CE, and the corresponding entry may include a pair of a buffer size field and a remaining time field, where the buffer size field indicates the total amount of delay-reporting data in all DSR-triggered logical channels with remaining time greater than or equal to RT₂ and smaller than RT₃, and the remaining time field indicates the shortest remaining value of running PDCP discardTimers among all PDCP SDUs in all DSR-triggered logical channels with remaining time greater than or equal to RT₂ and smaller than RT₃. For group P4, there may be no entry of delay status information to be reported in the Multiple Entry DSR MAC CE, since all data in group P4 is with remaining time greater than or equal to RT3.

To further clarify, if pdu-SetDiscard (i.e., an indicator of whether the UE the UEs supports PDU set based discard operation) is not configured, a delay-reporting PDCP SDU associated with the i^{th} dsr-ReportingThreshold is a PDCP SDU for which the remaining time till discardTimer expiry is less than the i^{th} dsr-ReportingThreshold and larger than or equal to the (i-1)^{th} dsr-ReportingThreshold (if i>1) or larger than zero (if i=1). Otherwise, if pdu-SetDiscard is configured, a delay-reporting PDCP SDU associated with the i^{th} dsr-ReportingThreshold is a PDCP SDU belonging to a PDU Set of which the PDU Set remaining time (i.e., the shortest remaining time till discardTimer expiry among the PDCP SDUs belonging to the PDU Set) is less than the i^{th} dsr-ReportingThreshold and larger than or equal to the (i-1)^{th} dsr-ReportingThreshold (if i>1) or larger than zero (if i=1). In addition, a non-delay-reporting PDCP SDU associated with the i^{th} dsr-ReportingThreshold is a PDCP SDU that will be transmitted prior to any of the delay-reporting PDCP SDUs associated with the i^{th} dsr-ReportingThreshold.

In some implementations, the delay status information associated with different reporting thresholds in the LCGᵢ may be reported consecutively in ascending order based on the values of the reporting thresholds. That is, the entry of delay status information associated with a smaller reporting threshold may be reported in lower octets, and the entry of delay status information associated with a larger reporting threshold may be reported in higher octets. For example, as shown in FIG. 4, the entry of delay status information associated with RT₁ is reported in octet 2k and octet 2k+1, the entry of delay status information associated with RT₂ is reported in octet 2k+2 and octet 2k+3, and the entry of delay status information associated with RT₃ is reported in octet 2k+4 and octet 2k+5.

In some implementations, for the buffer size field in each entry of the delay status information, the total amount of the delay-reporting data may be determined according to a data volume calculation procedure for associated radio link control (RLC) and PDCP entities. Additionally, or optionally, the UE may include the non-delay-reporting data (e.g., non-delay-reporting PDCP SDUs) ahead of the delay-reporting data in the data volume calculation for delay status report using multiple reporting thresholds, e.g., if the UE supports such capability and the network also indicates the UE to enable this capability. That is, the buffer size field in each entry of the delay status information may indicate the total amount of the delay-reporting data and non-delay reporting data. In one example, the UE may report to the network (e.g., via a UE Capability Transfer message) its capability information indicating whether it supports the delay status report of the buffered data using multiple reporting thresholds (e.g., such indication may be configured in a MAC parameter called “multipleEntryDelayStatusReport-r19”), and whether it supports including non-delay-reporting data ahead of delay-reporting data in the data volume calculation for delay status report using multiple reporting thresholds (e.g., such indication may be configured in a MAC parameter called “delayStatusReportNonDelayReportingData-r19”). In one example, a UE supporting the feature of including non-delay-reporting data in the data volume calculation should also indicate support of multipleEntryDelayStatusReport-r19. In one example, the network may include an indicator (e.g., dsr-ReportNonDelayCriticalData-r19) in the MAC-CellGroupConfig IE to enable the UE to report the non-delay-reporting data in the DSR procedure.

In some implementations, a UE supporting delay status report using multiple reporting thresholds may also support the legacy delay status report of the buffered data (i.e., report only a single pair of a remaining time field and a buffer size for an LCG, without the configuration of the reporting thresholds).

In some implementations, at least one of the configured reporting thresholds in DSR-reportingThresList for the LCGᵢ may be configured with a value greater than or equal to that of the configured triggering threshold (i.e., remainingTimeThreshold) for the LCGᵢ. Accordingly, this configuration may avoid the undesirable situation in which all reporting thresholds are smaller than the triggering threshold and the UE may have nothing to report when the DSR procedure is triggered by only PDCP SDU(s) with remaining time larger than the largest reporting threshold and smaller than the triggering threshold (i.e., there is no other PDCP SDUs in the LCGᵢ with remaining time smaller than any reporting threshold). Alternatively, if all configured reporting thresholds in DSR-reportingThresList for the LCGᵢ are smaller than the configured triggering threshold (i.e., remainingTimeThreshold) for the LCGᵢ, then the triggering threshold may be used as an additional reporting threshold for the LCGᵢ.

Under another proposed scheme of the present disclosure, when a UE is configured to apply the enhanced DSR procedure for an LCG with a triggering threshold (i.e., remainingTimeThreshold) but no reporting threshold is configured for this LCG (e.g., DSR-reportingThresList is not configured in the MAC-CellGroupConfig IE for this LCG, or no DSR-ReportingThreshold is configured in DSR-reportingThresList), the UE may be allowed to use the triggering threshold or a pre-determined/default value as a reporting threshold for reporting the delay status information for this LCG in a Multiple Entry DSR MAC CE when the enhanced DSR procedure is triggered for the logical channel(s) within this LCG. Alternatively, when this situation occurs, the UE may be allowed to not report the delay status information for this LCG in a Multiple Entry DSR MAC CE when the enhanced DSR procedure is triggered for the logical channel(s) within this LCG.

### Illustrative Implementations

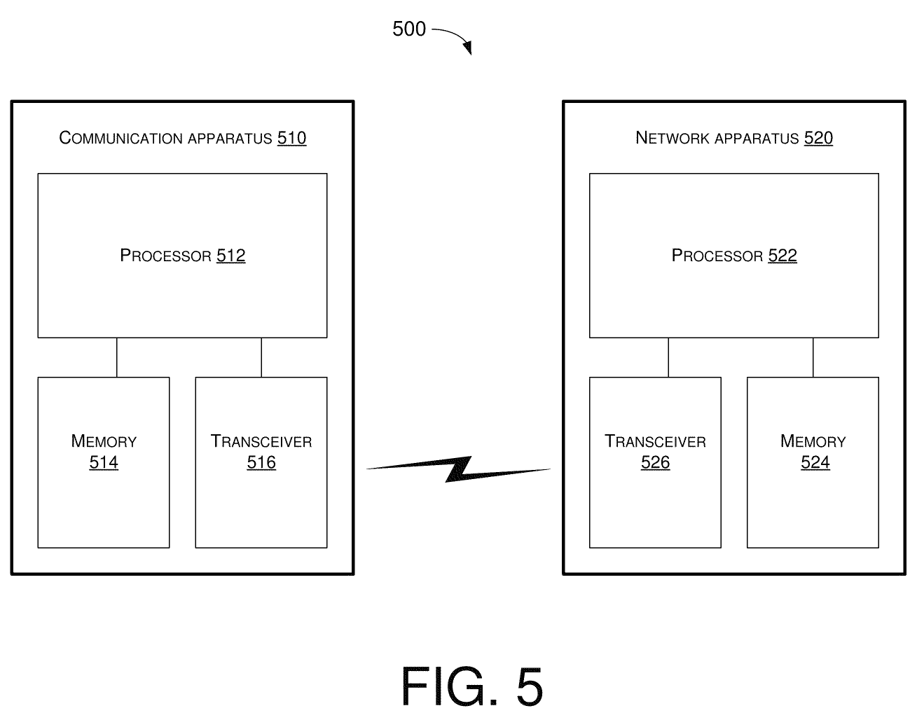

FIG. 5 illustrates an example communication system 500 having an example communication apparatus 510 and an example network apparatus 520 in accordance with an implementation of the present disclosure. Each of communication apparatus 510 and network apparatus 520 may perform various functions to implement schemes, techniques, processes, and methods described herein pertaining to configuration of enhanced DSR in mobile communications, including scenarios/schemes described above as well as processes 600 and 700 described below.

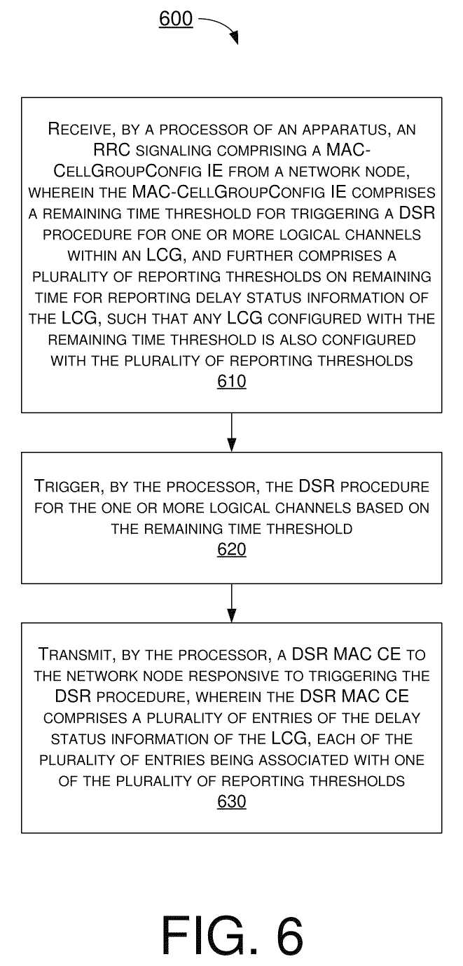

Communication apparatus 510 may be a part of an electronic apparatus, which may be a dual-steer device containing one or more UEs such as a portable or mobile apparatus, a wearable apparatus, a wireless communication apparatus, or a computing apparatus. For instance, communication apparatus 510 may be implemented in a smartphone, a smartwatch, a personal digital assistant, an electronic control unit (ECU) in a vehicle, a digital camera, or a computing equipment such as a tablet computer, a laptop computer, or a notebook computer. Communication apparatus 510 may also be a part of a machine type apparatus, which may be an IoT, NB-IoT, eMTC, IIoT UE, such as an immobile or a stationary apparatus, a home apparatus, a roadside unit (RSU), a wire communication apparatus, or a computing apparatus. For instance, communication apparatus 510 may be implemented in a smart thermostat, a smart fridge, a smart door lock, a wireless speaker, or a home control center. Alternatively, communication apparatus 510 may be implemented in the form of one or more integrated-circuit (IC) chips, such as, for example and without limitation, one or more single-core processors, one or more multi-core processors, one or more reduced-instruction-set computing (RISC) processors, or one or more complex-instruction-set-computing (CISC) processors. Communication apparatus 510 may include at least some of those components shown in FIG. 5, such as a processor 512, for example. Communication apparatus 510 may further include one or more other components not pertinent to the proposed schemes of the present disclosure (e.g., internal power supply, display device and/or user interface device), and, thus, such component(s) of communication apparatus 510 are neither shown in FIG. 6 nor described below in the interest of simplicity and brevity.

Network apparatus 520 may be a part of an electronic apparatus, which may be a network node such as a satellite, a BS, a small cell, a router, or a gateway of a 4G/5G/B5G/6G, NR, IoT, NB-IoT, or IIoT network. Alternatively, network apparatus 520 may be implemented in the form of one or more IC chips, such as, for example and without limitation, one or more single-core processors, one or more multi-core processors, or one or more RISC or CISC processors. Network apparatus 520 may include at least some of those components shown in FIG. 5, such as a processor 522, for example. Network apparatus 520 may further include one or more other components not pertinent to the proposed scheme of the present disclosure (e.g., internal power supply, display device and/or user interface device), and, thus, such component(s) of network apparatus 520 are neither shown in FIG. 5 nor described below in the interest of simplicity and brevity.

In one aspect, each of processor 512 and processor 522 may be implemented in the form of one or more single-core processors, one or more multi-core processors, or one or more CISC processors. That is, even though a singular term “a processor” is used herein to refer to processor 512 and processor 522, each of processor 512 and processor 522 may include multiple processors in some implementations and a single processor in other implementations in accordance with the present disclosure. In another aspect, each of processor 512 and processor 522 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of processor 512 and processor 522 is a special-purpose machine specifically designed, arranged and configured to perform specific tasks in a device (e.g., as represented by communication apparatus 510) and a network node (e.g., as represented by network apparatus 520) in accordance with various implementations of the present disclosure.

In some implementations, communication apparatus 510 may also include a transceiver 516 coupled to processor 512 and capable of wirelessly transmitting and receiving data. In some implementations, transceiver 516 may be capable of wirelessly communicating with different types of UEs and/or wireless networks of different RATs. In some implementations, transceiver 516 may be equipped with a plurality of antenna ports (not shown) such as, for example, four antenna ports. That is, transceiver 516 may be equipped with multiple transmit antennas and multiple receive antennas for multiple-input multiple-output (MIMO) wireless communications. In some implementations, network apparatus 520 may also include a transceiver 526 coupled to processor 522. Transceiver 526 may include a transceiver capable of wirelessly transmitting and receiving data. In some implementations, transceiver 526 may be capable of wirelessly communicating with different types of UEs of different RATs. In some implementations, transceiver 526 may be equipped with a plurality of antenna ports (not shown) such as, for example, four antenna ports. That is, transceiver 526 may be equipped with multiple transmit antennas and multiple receive antennas for MIMO wireless communications.

In some implementations, communication apparatus 510 may further include a memory 514 coupled to processor 512 and capable of being accessed by processor 512 and storing data therein. In some implementations, network apparatus 520 may further include a memory 524 coupled to processor 522 and capable of being accessed by processor 522 and storing data therein. Each of memory 514 and memory 524 may include a type of random-access memory (RAM) such as dynamic RAM (DRAM), static RAM (SRAM), thyristor RAM (T-RAM), and/or zero-capacitor RAM (Z-RAM). Alternatively, or additionally, each of memory 514 and memory 524 may include a type of read-only memory (ROM) such as mask ROM, programmable ROM (PROM), erasable programmable ROM (EPROM), and/or electrically erasable programmable ROM (EEPROM). Alternatively, or additionally, each of memory 514 and memory 524 may include a type of non-volatile random-access memory (NVRAM) such as flash memory, solid-state memory, ferroelectric RAM (FeRAM), magnetoresistive RAM (MRAM), and/or phase-change memory.

Each of communication apparatus 510 and network apparatus 520 may be a communication entity capable of communicating with each other using various proposed schemes in accordance with the present disclosure. For illustrative purposes and without limitation, a description of capabilities of communication apparatus 510, as a UE, and network apparatus 520, as a network node (e.g., BS), is provided below with processes 600 and 700.

### Illustrative Processes

FIG. 6 illustrates an example process 600 in accordance with an implementation of the present disclosure. Process 600 may be an example implementation of above scenarios/schemes, whether partially or completely, with respect to configuration of enhanced DSR in mobile communications. Process 600 may represent an aspect of implementation of features of communication apparatus 510. Process 600 may include one or more operations, actions, or functions as illustrated by one or more of blocks 610 to 630. Although illustrated as discrete blocks, various blocks of process 600 may be divided into additional blocks, combined into fewer blocks, or eliminated, depending on the desired implementation. Moreover, the blocks of process 600 may be executed in the order shown in FIG. 6 or, alternatively in a different order. Process 600 may be implemented by or in communication apparatus 510 or any suitable UE or machine type device. Solely for illustrative purposes and without limiting the scope, process 600 is described below in the context of communication apparatus 510, as a UE, and network apparatus 520, as a network node (e.g., a BS such as gNB). Process 600 may begin at block 610.

At block 610, process 600 may involve processor 512 of communication apparatus 510, receiving, via transceiver 516, an RRC signaling comprising a MAC-CellGroupConfig IE from network apparatus 520, wherein the MAC-CellGroupConfig IE comprises a remaining time threshold for triggering a DSR procedure for one or more logical channels within an LCG, and further comprises a plurality of reporting thresholds on remaining time for reporting delay status information of the LCG, such that any LCG configured with the remaining time threshold is also configured with the plurality of reporting thresholds. Process 600 may proceed from block 610 to block 620.

At block 620, process 600 may involve processor 512 triggering the DSR procedure for the one or more logical channels within the LCG based on the remaining time threshold. Process 600 may proceed from block 620 to block 630.

At block 630, process 600 may involve processor 512 transmitting, via transceiver 516, a DSR MAC CE to network apparatus 520 responsive to triggering the DSR procedure, wherein the DSR MAC CE comprises a plurality of entries of the delay status information of the LCG, each of the plurality of entries being associated with one of the plurality of reporting thresholds.

In some implementations, at least one of the plurality of reporting thresholds may be greater than or equal to the remaining time threshold.

In some implementations, the multiple entries of the delay status information may be reported consecutively in an ascending order based on values of the plurality of reporting thresholds.

In some implementations, the MAC-CellGroupConfig IE may include a DSR reporting threshold list, and the plurality of reporting thresholds may be configured in an ascending order in the DSR reporting threshold list.

In some implementations, each of the multiple entries of the delay status information may include a pair of a remaining time field and a buffer size field.

In some implementations, for each of the multiple entries of the delay status information, the remaining time field may indicate a shortest remaining time of running PDCP discard timers among all PDCP SDUs that have not been transmitted in any MAC PDU and are associated with the one of the plurality of reporting thresholds.

In some implementations, for each of the multiple entries of the delay status information, the buffer size field may indicate a total amount of delay-reporting data associated with the one of the plurality of reporting thresholds.

In some implementations, for each of the multiple entries of the delay status information, the buffer size field may indicate a total amount of delay-reporting data and non-delay-reporting data ahead of the delay-reporting data associated with the one of the plurality of reporting thresholds, in an event that the MAC-CellGroupConfig IE further comprises an indicator enabling communication apparatus 510 to report the non-delay-reporting data.

In some implementations, the indicator may be configured in the MAC-CellGroupConfig IE in an event that communication apparatus 510 has previously transmitted UE capability information to network apparatus 520, and the UE capability information indicates that communication apparatus 510 supports reporting the delay status information using the plurality of reporting thresholds and supports including the non-delay-reporting data ahead of the delay-reporting data for the reporting of the delay status information.

In some implementations, the UE capability information may further indicate that communication apparatus 510 supports reporting the delay status information without using the plurality of reporting thresholds.

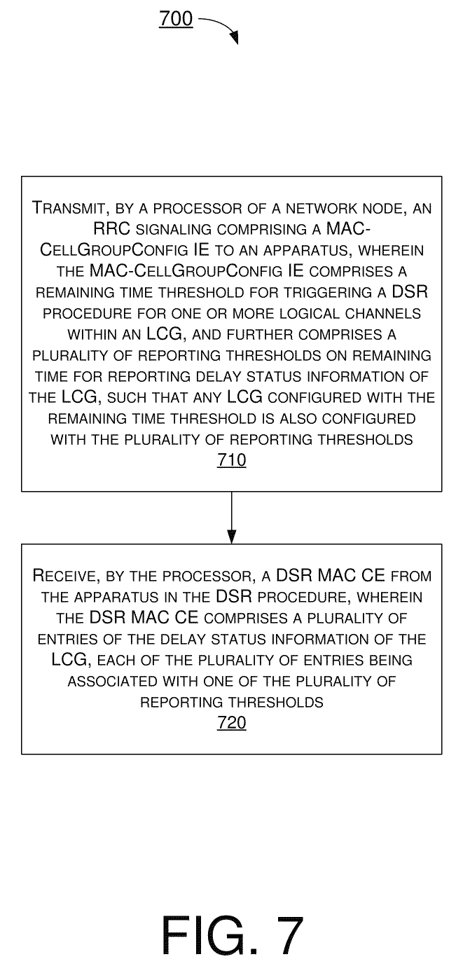

FIG. 7 illustrates an example process 700 in accordance with an implementation of the present disclosure. Process 700 may be an example implementation of above scenarios/schemes, whether partially or completely, with respect to configuration of enhanced DSR in mobile communications. Process 700 may represent an aspect of implementation of features of network apparatus 520. Process 700 may include one or more operations, actions, or functions as illustrated by one or more of blocks 710 to 720. Although illustrated as discrete blocks, various blocks of process 700 may be divided into additional blocks, combined into fewer blocks, or eliminated, depending on the desired implementation. Moreover, the blocks of process 700 may be executed in the order shown in FIG. 7 or, alternatively in a different order. Process 700 may be implemented by or in network apparatus 520 as well as any variations thereof. Solely for illustrative purposes and without limiting the scope, process 700 is described below in the context of communication apparatus 510, as a UE, and network apparatus 520, as a network node (e.g., a BS such as gNB). Process 700 may begin at block 710.

At block 710, process 700 may involve processor 522 of network apparatus 520, transmitting, via transceiver 526, an RRC signaling comprising a MAC-CellGroupConfig IE to communication apparatus 510, wherein the MAC-CellGroupConfig IE comprises a remaining time threshold for triggering a DSR procedure for one or more logical channels within an LCG, and further comprises a plurality of reporting thresholds on remaining time for reporting delay status information of the LCG, such that any LCG configured with the remaining time threshold is also configured with the plurality of reporting thresholds. Process 700 may proceed from block 710 to block 720.

At block 720, process 700 may involve processor 522 receiving, via transceiver 526, a DSR MAC CE from communication apparatus 510 in the DSR procedure, wherein the DSR MAC CE comprises a plurality of entries of the delay status information of the LCG, each of the plurality of entries being associated with one of the plurality of reporting thresholds.

In some implementations, at least one of the plurality of reporting thresholds may be greater than or equal to the remaining time threshold.

In some implementations, the multiple entries of the delay status information may be reported consecutively in an ascending order based on values of the plurality of reporting thresholds.

In some implementations, the MAC-CellGroupConfig IE may include a DSR reporting threshold list, and the plurality of reporting thresholds may be configured in an ascending order in the DSR reporting threshold list.

In some implementations, each of the multiple entries of the delay status information may include a pair of a remaining time field and a buffer size field.

In some implementations, for each of the multiple entries of the delay status information, the remaining time field may indicate a shortest remaining time of running PDCP discard timers among all PDCP SDUs that have not been transmitted in any MAC PDU and are associated with the one of the plurality of reporting thresholds.

In some implementations, for each of the multiple entries of the delay status information, the buffer size field may indicate a total amount of delay-reporting data associated with the one of the plurality of reporting thresholds.

In some implementations, for each of the multiple entries of the delay status information, the buffer size field may indicate a total amount of delay-reporting data and non-delay-reporting data ahead of the delay-reporting data associated with the one of the plurality of reporting thresholds, in an event that the MAC-CellGroupConfig IE further comprises an indicator enabling communication apparatus 510 to report the non-delay-reporting data.

In some implementations, the indicator may be configured in the MAC-CellGroupConfig IE in an event that communication apparatus 510 has previously transmitted UE capability information to network apparatus 520, and the UE capability information indicates that communication apparatus 510 supports reporting the delay status information using the plurality of reporting thresholds and supports including the non-delay-reporting data ahead of the delay-reporting data for the reporting of the delay status information.

In some implementations, the UE capability information may further indicate that communication apparatus 510 supports reporting the delay status information without using the plurality of reporting thresholds.

In light of the above-described embodiments, it is noteworthy that, by applying the schemes of the present disclosure, the DSR procedure is enhanced by configuring both the triggering threshold and multiple reporting thresholds for an LCG, so as to ensure that if at least one LCG is configured with a DSR reporting threshold list, any LCG configured with a remaining time threshold is also configured with a DSR reporting threshold list. Accordingly, normal operation of the enhanced DSR procedure may be ensured to efficiently report delay status information with more details and/or with finer granularity regarding the delay-critical data buffered in the LCG, thereby improving the efficiency and effectiveness of UL data and resource scheduling.

### Additional Notes

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. An apparatus, comprising:
a transceiver which, during operation, wirelessly communicates with a network node; and
a processor communicatively coupled to the transceiver such that, during operation, the processor performs operations comprising:
receiving, via the transceiver, a radio resource control (RRC) signaling comprising a MAC-CellGroupConfig information element (IE) from the network node, wherein the MAC-CellGroupConfig IE comprises a remaining time threshold for triggering a delay status reporting (DSR) procedure for one or more logical channels within a logical channel group (LCG), and further comprises a plurality of reporting thresholds on remaining time for reporting delay status information of the LCG, such that any LCG configured with the remaining time threshold is also configured with the plurality of reporting thresholds;
triggering the DSR procedure for the one or more logical channels within the LCG based on the remaining time threshold; and
transmitting, via the transceiver, a DSR medium access control (MAC) control element (CE) to the network node responsive to triggering the DSR procedure, wherein the DSR MAC CE comprises multiple entries of the delay status information of the LCG, each of the multiple entries being associated with one of the plurality of reporting thresholds.

2. The apparatus of claim 1, wherein at least one of the plurality of reporting thresholds is greater than or equal to the remaining time threshold.

3. The apparatus of claim 1, wherein the multiple entries of the delay status information are reported consecutively in an ascending order based on values of the plurality of reporting thresholds.

4. The apparatus of claim 1, wherein the MAC-CellGroupConfig IE comprises a DSR reporting threshold list, and the plurality of reporting thresholds are configured in an ascending order in the DSR reporting threshold list.

5. The apparatus of claim 1, wherein each of the multiple entries of the delay status information comprises a pair of a remaining time field and a buffer size field.

6. The apparatus of claim 5, wherein for each of the multiple entries of the delay status information, the remaining time field indicates a shortest remaining time of running packet data convergence protocol (PDCP) discard timers among all PDCP service data units (SDUs) that have not been transmitted in any MAC protocol data unit (PDU) and are associated with the one of the plurality of reporting thresholds.

7. The apparatus of claim 5, wherein for each of the multiple entries of the delay status information, the buffer size field indicates a total amount of delay-reporting data associated with the one of the plurality of reporting thresholds.

8. The apparatus of claim 5, wherein for each of the multiple entries of the delay status information, the buffer size field indicates a total amount of delay-reporting data and non-delay-reporting data ahead of the delay-reporting data associated with the one of the plurality of reporting thresholds, in an event that the MAC-CellGroupConfig IE further comprises an indicator enabling the apparatus to report the non-delay-reporting data.

9. The apparatus of claim 8, wherein the indicator is configured in the MAC-CellGroupConfig IE in an event that the apparatus has previously transmitted user equipment (UE) capability information to the network node, and the UE capability information indicates that the apparatus supports reporting the delay status information using the plurality of reporting thresholds and supports including the non-delay-reporting data ahead of the delay-reporting data for the reporting of the delay status information.

10. The apparatus of claim 9, wherein the UE capability information further indicates that the apparatus supports reporting the delay status information without using the plurality of reporting thresholds.

11. A network node, comprising:
a transceiver which, during operation, wirelessly communicates with an apparatus; and
a processor communicatively coupled to the transceiver such that, during operation, the processor performs operations comprising:
transmitting, via the transceiver, a radio resource control (RRC) signaling comprising a MAC-CellGroupConfig information element (IE) to the apparatus, wherein the MAC-CellGroupConfig IE comprises a remaining time threshold for triggering a delay status reporting (DSR) procedure for one or more logical channels within a logical channel group (LCG), and further comprises a plurality of reporting thresholds on remaining time for reporting delay status information of the LCG, such that any LCG configured with the remaining time threshold is also configured with the plurality of reporting thresholds; and
receiving, via the transceiver, a DSR medium access control (MAC) control element (CE) from the apparatus in the DSR procedure, wherein the DSR MAC CE comprises multiple entries of the delay status information of the LCG, each of the multiple entries being associated with one of the plurality of reporting thresholds.

12. The network node of claim 11, wherein at least one of the plurality of reporting thresholds is greater than or equal to the remaining time threshold.

13. The network node of claim 11, wherein the multiple entries of the delay status information are reported consecutively in an ascending order based on values of the plurality of reporting thresholds.

14. The network node of claim 11, wherein the MAC-CellGroupConfig IE comprises a DSR reporting threshold list, and the plurality of reporting thresholds are configured in an ascending order in the DSR reporting threshold list.

15. The network node of claim 11, wherein each of the multiple entries of the delay status information comprises a pair of a remaining time field and a buffer size field.

16. The network node of claim 15, wherein for each of the multiple entries of the delay status information, the remaining time field indicates a shortest remaining time of running packet data convergence protocol (PDCP) discard timers among all PDCP service data units (SDUs) that have not been transmitted in any MAC protocol data unit (PDU) and are associated with the one of the plurality of reporting thresholds.

17. The network node of claim 15, wherein for each of the multiple entries of the delay status information, the buffer size field indicates a total amount of delay-reporting data associated with the one of the plurality of reporting thresholds.

18. The network node of claim 15, wherein for each of the multiple entries of the delay status information, the buffer size field indicates a total amount of delay-reporting data and non-delay-reporting data ahead of the delay-reporting data associated with the one of the plurality of reporting thresholds, in an event that the MAC-CellGroupConfig IE further comprises an indicator enabling the apparatus to report the non-delay-reporting data.

19. The network node of claim 18, wherein the indicator is configured in the MAC-CellGroupConfig IE in an event that the apparatus has previously transmitted user equipment (UE) capability information to the network node, and the UE capability information indicates that the apparatus supports reporting the delay status information using the plurality of reporting thresholds and supports including the non-delay-reporting data ahead of the delay-reporting data for the reporting of the delay status information.

20. The network node of claim 19, wherein the UE capability information further indicates that the apparatus supports reporting the delay status information without using the plurality of reporting thresholds.
